(19) United States
(12) Patent Application Publication
(10) Pub. No.: US 2008/0255204 A1
(43) Pub. Date: Oct. 16, 2008

(54) Agrochemical Formulation for Improving the Action and Plant Compatibility of Crop Protection Agents

(75) Inventors: Lorna Elizabeth Davies, Kansas city, MS (US); Wolfgang Thielert, Odenthal (DE); Jurgen Thomzik, Langenfeld (DE); Heike Hungenberg, Langenfeld (DE); Peter Baur, Schondorf (DE); Roland Giebner, Monheim (DE); Karin Jorges, Odenthal (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: BAYER CROPSCIENCE AG, MONHEIM (DE)

(21) Appl. No.: 11/817,065

(22) PCT Filed: Feb. 14, 2006
(86) PCT No.: PCT/EP2006/001321

§ 371 Date: Apr. 7, 2008

(30) Foreign Application Priority Data
Feb. 26, 2005 (DE) 10 2005 008 949.6

(51) Int. Cl. A01N 43/40; A01N 25/00; A01P 7/02; A01P 5/00

(52) U.S. Cl. 514/341; 514/772; 514/772.3

(57) ABSTRACT

The present invention relates to novel agrochemical formulations for treating plants, which formulations comprise, as cosolvent, propylene carbonate, and, if appropriate, further additives, to a process for preparing these formulations and to their use for treating plants and/or their habitat and for increasing the efficacy and plant compatibility of crop protection agents.

The present invention relates to novel agrochemical formulations for treating plants, to a process for preparing these formulations and to their use for treating plants and/or their habitat.

Agrochemical formulations providing a given crop protection agent in the form of a water-soluble concentrate (soluble liquid, SL), such as, for example, Confidor® SL 200 (Bayer CropScience AG, Monheim, Germany) are already known. These SL formulations comprise, for example, emulsifiers and/or dispersants, solvents and, additionally, the cosolvent N-methylpyrrolidone (NMP). In general, the efficacy of these agrochemical active compound formulations is very good.

In the context of research for novel agrochemical auxiliaries which improve the environmental properties of such formulations, we investigated alternatives to the solvent NMP (N-methylpyrrolidone). However, substitution of the NMP was not to affect the quality of the formulations. Thus, the amount of the crop protection agent applied should remain as low as possible, and the action of the crop protection agent should not be reduced. At the same time, it was to be ensured that the formulations are easy to apply on the field, for example by means of customary machinery. This invention also provides novel agrochemical SL formulations which allow a considerably improved uptake of the formulated active compound or the formulated active compound combination via the leaves and, as a result, show considerably improved biological action.

These NMP-free formulations according to the invention comprise, in addition to the crop protection agent(s) in question, preferably at least one emulsifier, if appropriate at least one dispersant, at least one solvent and, instead of the cosolvent NMP, propylene carbonate.

The concentration of the individual components in the formulations according to the invention can be varied within a relatively wide range.

Thus, the content of crop protection agent or combination of crop protection agents is from 0.1 to 40% by weight, preferably from 5 to 25% by weight, the content of emulsifiers from 0.5 to 30% by weight, preferably from 0.5 to 15% by weight, the content of dispersant is generally from 0 to 10% by weight, preferably from 0.5 to 2% by weight, the content of solvent is generally from 30 to 90% by weight, preferably from 50 to 70% by weight, and the content of propylene carbonate is generally from 10 to 50% by weight, preferably from 15 to 25% by weight. The sum of the individual components and possible further ingredients of the formulation is always 100%. The components of the formulation according to the invention are generally present in at least the following amounts and forms (unless stated otherwise, all stated figures are in percent by weight):

a) crop protection agent: 0.1-40% by weight
b) emulsifier: 0.5-30% by weight
c) dispersant: 0-10% by weight
d) solvent: 30-90% by weight
e) propylene carbonate: 10-50% by weight.

The individual ingredients to be used for a formulation of crop protection agents are generally known to the person skilled in the art and commercially available.

The formulation according to the invention is particularly suitable for formulating insecticidally active compounds.

The formulation according to the invention is especially suitable for formulating active compounds from the class of the neonicotinoids, such as, for example, the active compounds imidacloprid (CAS RN 138261-41-3), clothianidin (CAS RN 210880-92-5), thiacloprid (CAS RN 111988-49-9), thiamethoxam (CAS RN 153719-23-4), nitenpyram (CAS RN 150824-47-8), acetamiprid (CAS RN 135410-20-7) or dinotefuran (CAS RN 165252-70-0). In the same preferred manner, the formulations according to the invention are suitable for formulating combinations of the abovementioned active compounds imidacloprid, clothianidin, thiacloprid, thiamethoxam, nitenpyram, acetamiprid, and dinotefuran with further active compounds, such as, for example, further insecticides, fungicides, plant compatibility-improving active compounds (safeners) or growth-promoting substances, etc., and also combinations of two or more of the neonicotinoids mentioned with one another, such as, for example, the combination of imidacloprid and clothianidin.

The formulations according to the invention are especially well suited for formulating the active compound imidacloprid. Imidacloprid (CAS RN 138261-41-3) is known from -A1 0 192 060. In the context of the present invention, imidacloprid is emphasized as a particularly preferred active compound which can be formulated in a particularly advantageous manner with the formulation according to the invention, if appropriate in combination with further crop protection agents.

Suitable emulsifiers are all customary nonionic, anionic, cationic and zwitterionic compounds with surfactant properties which are customarily employed in agrochemical compositions. These compounds include reaction products of fatty acids, fatty esters, fatty alcohols, fatty amines, alkylphenols or alkylarylphenols with ethylene oxide and/or propylene oxide and/or butylene oxide, and also their sulphuric esters, phosphoric monoesters and phosphoric diesters, furthermore reaction products of ethylene oxide with propylene oxide, and also alkylsulphonates, alkyl sulphates, aryl sulphates, tetraalkylammonium halides, trialkylarylammonium halides and alkylaminesulphonates. The emulsifiers can be employed individually or else as a mixture. Reaction products of castor oil with ethylene oxide in a molar ratio of from 1:20 to 1:60, reaction products of C₆-C₂₀-alcohols with ethylene oxide in a molar ratio of from 1:5 to 1:50, reaction products of fatty amines with ethylene oxide in a molar ratio of from 1:2 to 1:25, reaction products of 1 mol of phenol with 2 to 3 mol of styrene and 10 to 50 mol of ethylene oxide, reaction products of C₈-C₁₂-alkylphenols with ethylene oxide in a molar ratio of from 1:5 to 1:30, alkylglycosides, salts of C₈-C₁₆-alkylbenzenesulphonic acid, such as, for example, calcium, monoethanolammonium, diethanolammonium and triethanolammonium salts, may be mentioned as being preferred.

Examples of nonionic emulsifiers which may be mentioned are the products known under the names Sapogenat T180 (=tri-sec-butylphenol ethoxylate, from Clariant), Alkamuls OR36 (=castor oil ethoxylate, from Rhodia) und Emulsogen TS54 (=tristyrylphenol ethoxylate, Clariant). Preferred for use in the formulations according to the invention are the tristyrylphenol ethoxylates (Emulsogen TS54). Examples of anionic emulsifiers which may be mentioned are the Bayer AG product which is commercially available under the name Baykanol SL (=condensate of sulphonated ditolyl ether with formaldehyde), and also phosphated or sulphated tristyrylphenol ethoxylates, where specific mention may be made of Soprophor FLK and Soprophor 4D 384 (from Rhodia).

Suitable dispersants which may be present in the crop treatment compositions according to the invention are all compounds customarily used for such purposes in agrochemical compositions. In the formulations according to the invention, preference is given to using copolymers of polyvinylpyrrolidone and polyvinyl acetate which are generally present in a ratio of from 60 to 40. An example of such a copolymer is Luvitec VA 64 (BASF) which is commercially available. Vinylpyrrolidone/vinyl acetate copolymers 60:40 are particularly suitable for preparing the formulations according to the invention.

Suitable solvents which may be present in the crop treatment compositions according to the invention are all compounds which are customarily used for such purposes in agrochemical compositions. Dimethyl sulphoxide, H₃C—SO—CH₃, for example, has extremely good solvent properties and is frequently used for preparing SL formulations, and is also preferred for the formulations according to the invention.

Propylene carbonate (CAS No. 108-32-7) is a clear colourless, almost odourless liquid which is, under most conditions, stable and non-corrosive. As a solvent, propylene carbonate is used in the most different items, such as, for example, in inks, dyes, for removing coatings and paints, in all-purpose cleaners, in materials for removing fat, in cleaners for metal and machinery, in tar removers. In the context of the present studies it was surprisingly found that propylene carbonate is not only suitable as an adequate substitute for NMP but, surprisingly, also improves foliar penetration of an active compound formulated according to the invention alone or else in tank mixes with additives customary for such mixtures. In the present invention, for the first time, it is shown that propylene carbonate can be used as a base for formulations of crop protection agents, which formulations have excellent activity and are easy to use. Suitable further additives which may be present in the formulations according to the invention are further agrochemically active compounds, and also crystallization inhibitors, wetting agents and also water.

Suitable agrochemically active compounds are preferably substances having insecticidal, acaricidal and/or fungicidal properties.

Cypeirmethrin, deltamethrin, permethrin, natural pyrethrum, fenpropathrin, cyfluthrin, β-cyfluthrin, methiocarb, thiodicarb, aldicarb and, from the group of the ketoenol derivatives, 3-(2,4-dichlorophenyl)-4-(1,1-dimethylpropylcarbonyloxy)-5-spiro-cyclohexyl-3-dihydrofuran-2-one, 3-(2,4,6-trimethylphenyl)-4-(2,2-dimethylpropylcarbonyloxy)-5-spiro-cyclopentyl-3-dihydrofuran-2-one and cis-4-(ethoxycarbonyloxy)-8-methoxy-3-(2,5-xylyl)-1-azaspiro[4.5]dec-3-en-2-one may be mentioned by way of example. Suitable fungicides are preferably active compounds from the group of the azoles, the strobilurin derivatives and the amino acid derivatives. Tebuconazol, prothioconazol, cyproconazol, triticonazol, triadimenol, myclobutanil, fluoxastrobin, fluquinconazole, trifloxystrobin, azoxystrobin, kresoxim-methyl, pyraclostrobin, 3-[1-(2-[4-(2-chlorophenoxy)-5-fluoropyrimid-6-yloxy]phenyl)-1-(methoximino)methyl]-5,6-dihydro-1,4,2-dioxazine, carpropamid and iprovalicarb may be mentioned by way of example.

Suitable crystallization inhibitors which may be present in the crop treatment compositions according to the invention are all compounds customarily used for such purposes in agrochemical compositions. Copolymers of polyvinylpyrrolidone and polyvinyl alcohol, such as, for example, the polyvinylpyrrolidone/polyvinyl alcohol copolymer known under the name Luvitec VA 64 (from BASF), furthermore dimethyl alkylcarboxamides, such as dimethyl decanecarboxamide, or the dimethyl C6-12-alkanecarboxamide mixtures known under the name Hallcomid® (from. Hall Comp.) may he mentioned as being preferred, and moreover copolymers of ethylene diamine with ethylene oxide and propylene oxide, such as, for example, the product known under the name Synperonic T 304 (from Uniqema).

Suitable wetting agents are all compounds customarily used for such purposes in crop treatment compositions. Alkylphenol ethoxylates, dialkyl sulphosuccinates, such as dioctyl sulphosuccinate sodium, lauryl ether sulphates and polyoxyethylene sorbitan fatty esters may be mentioned as being preferred.

The formulations according to the invention are generally prepared by mixing the liquid components of the formulation in any order with stirring at room temperature. Solid components may be dissolved in the resulting mixture (see also Ex. 1).

The agrochemical formulations according to the invention are preferably prepared by
a) dissolving the active compound or the active compounds in the solvent or in the solvent/cosolvent mixture,
b) adding the emulsifier and the dispersant with stirring, and
c) stirring the components until a clear homogeneous solution has been formed.

Suitable for preparing the crop treatment compositions according to the invention are customary apparatuses used for preparing agrochemical formulations.

The application rate of the crop treatment compositions according to the invention can be varied within a relatively wide range. It depends on the active compounds present in each case, and on their concentration in the formulations.

It has been found that the agrochemical formulations according to the invention are highly suitable for applying the active compounds contained therein to plants including seedlings, leaves, flowers, stems/trunk and the habitat of plants, i.e. the soil, but also soil-free substrates.

The formulations according to the invention are distinguished in particular by the fact that, by using propylene carbonate, the biological efficacy of an active compound formulation is increased considerably (see Examples 2 to 5).

As active compound, the formulations according to the invention preferably comprise an insecticide from the class of the neonicotinoids, especially preferably imidacloprid, and also propylene carbonate and the additives mentioned above.

The formulations according to the invention can be used in a particularly advantageous manner for treating cotton, citrus fruit, tomatoes, cucumbers, courgettes, aubergines, melons, cabbage species, potatoes, oilseed rape, pome fruit, stone fruit, soft fruit, grapevines, tobacco, maize, soybeans, sugarcane, ornamental plants, and also wheat, barley, rye, oats and triticale, furthermore for rice, peas, broad beans, cotton, sunflowers and beet, or else vegetable of different types. These include, inter alia, artichokes, cauliflower, broccoli, green beans, fennel, endive, kohlrabi, head lettuce, cress, leek vegetables, Swiss chard, carrots, bell peppers, rhubarb, beetroot, red cabbage, Brussel sprouts, celeriac, Savoy cabbage, chestnuts, runner beans, scorzonera, asparagus, cable beet, spinach, white cabbage, onions, courgettes.

The formulations can also be used for treating transgenic plants. Here, there may also be synergistic effects with the formulated active compound, such as, for example, imidacloprid, acting together with the substances formed by expression.

The formulations according to the invention and the formulations preparable therefrom by further mixing with formulation auxiliaries and/or crop treatment agents are highly suitable for applying agrochemically active compounds to plants and/or their habitat. They ensure that the active components are released over a relatively long period of time in the amount desired in each case. Accordingly, the present invention also provides methods for protecting plants against pests by treating the plants and/or their habitat with a formulation according to the invention. The invention also relates to the use of the formulation according to the invention for protecting plants against pests.

The abovementioned pests include:

From the order of the Isopoda, for example, Oniscus asellus, Armadillidium vulgare, Porcellio scaber. From the order of the Diplopoda, for example, Blaniulus guttulatus. From the order of the Chilopoda, for example, Geophilus carpophagus, Scutigera spp. From the order of the Symphyla, for example, Scutigerella immaculata. From the order of the Thysanura, for example, Lepisma saccharina. From the order of the Collembola, for example, Onychiurus armatus. From the order of the Orthoptera, for example, Acheta domesticus, Gryllotalpa spp., Locusta migratoria migratorioides, Melanoplus spp., Schistocerca gregaria. From the order of the Blattaria, for example, Blatta orientalis, Periplaneta americana, Leucophaea maderae, Blattella germanica. From the order of the Dermaptera, for example, Forficula auricularia. From the order of the Isoptera, for example, Reticulitermes spp. From the order of the Phthiraptera, for example, Pediculus humanus corporis, Haematopinus spp., Linognathus spp., Trichodectes spp., Damalinia spp. From the order of the Thysanoptera, for example, Hercinothrips femoralis, Thrips tabaci, Thrips palmi, Frankliniella occidentalis. From the order of the Heteroptera, for example, Eurygaster spp., Dysdercus intermedius, Piesma quadrata, Cimex lectularius, Rhodnius prolixus, Triatoma spp. From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp., Psylla spp. From the order of the Lepidoptera, for example, Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae. From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus. From the order of the Hymenoptera, for example, Diprion spp., Hoplocampa spp., Lasius spp., Monomorium pharaonis, Vespa spp. From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp. From the order of the Siphonaptera, for example, Xenopsylla cheopis, Ceratophyllus spp.

From the class of the arachnids, for example, Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.

The phytoparasitic nematodes include, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

In the context of the present invention, the formulation according to the invention can be applied to or into the soil or alternative cultivation substrates, such as, for example, peat, standard soil, mineral wool, nutrient solutions, irrigation water, etc., to the plants (for example foliar application) or parts of plants (for example stem application) or else to the seed of the plants mentioned above for the corresponding propagation material.

In general, when treating plants, the amount of the composition according to the invention and/or further additives applied has to be chosen such that the plant is not damaged. This has to be ensured especially in the case of active compounds which, at certain application rates, may show phytotoxic effects.

The application rate of the formulations according to the invention and the preparations preparable therefrom by further mixing with formulation auxiliaries can be varied within a relatively wide range. When treating parts of plants, the application rates of the active compound are generally between 0.1 and 10 000 g/ha, preferably between 10 and 1000 g/ha.

The preparation and the use of the formulations according to the invention is illustrated by the examples below.

### EXAMPLES

### Example 1

### Preparation of a Formulation According to the Invention Based on Imidacloprid and Propylene Carbonate

The liquid components listed in Table I below are, in any order, mixed with stirring at room temperature until a homogeneous liquid is obtained. Solid components are dissolved in the resulting mixture.

This gives a formulation with the following composition:

TABLE I

| | | Active compound |
|---|---|---|
| % by weight | Component | content in gram/litre |
| 17.1 | imidacloprid | 200 |
| 2.5 | tristyrylphenol 54M ethoxylate | |
| | (Emulsogen TS54) | |
| 1 | VP/VA copolymer (Luvitec | |
| | VA 64 from BASF) | |
| 20 | propylene carbonate S (BASF) | |
| (ad 100%) | dimethyl sulphoxide (DMSO) | |

### Example 2

### Determination of the Bioavailability (Penetration of the Cuticles) of the Formulated Active Compound in Confidor SL200 (Contains NMP) and an Analogous Formulation According to the Invention (Contains Propylene Carbonate Instead of NMP)

According to the invention, the known formulation “Confidor SL200”, which comprises the active compound imidacloprid and NMP, was modified such that NMP was replaced by propylene carbonate (for the composition, see Example 1). The two formulations were compared. What was examined was the penetration of the cuticles of apple leaves (Table A).

What was used were leaves which, fully developed, were cut from apple trees of the cultivar Golden Delicious. The cuticles were isolated by
initially filling leaf discs, the underside of which had been marked with dye and which had been punched out, by vacuum infiltration with a pectinase solution (0.2 to 2%) buffered to a pH between 3 and 4,
then adding sodium azide and
leaving the treated leaf discs until the original leaf structure had been dissolved and the non-cellular cuticles had been detached.

Subsequently, only the cuticles free from stomata and hairs, from the upper sides of the leaves, were used. Repeatedly, they were washed, alternating with water and a buffer solution pH 7. The resulting clean cuticles were then mounted on Teflon plates and straightened and dried using a gentle stream of air.

In the next step, the cuticle membranes obtained in this manner were, for membrane transport studies, placed into diffusion cells (=transport chambers) made from stainless steel. To this end, the cuticles were, using a pair of tweezers, placed into the middle of the edges of the diffusion cells, which had been coated with silicone fat, and the cuticles were closed using a ring which had also been treated with fat. The arrangement was chosen such that the morphological outside of the cuticles was facing out, i.e. to the atmosphere, whereas the original inside was facing to the inside of the diffusion cell. The diffusion cells were filled with water or a water/solvent mixture. For the spray liquors, use was in each case made of CIPAC water.

After the spray liquors had been applied, the water was in each case allowed to evaporate, and the chambers were then in each case turned over and placed into thermostated tubs. The penetration that set in took place at a relative atmospheric humidity of 60% and a temperature adjusted to 20° C. Using a syringe, samples were taken at regular intervals and, using HPLC, examined for the content of penetrated active compound.

The test results are shown in the table below.

TABLE A

| | Imidacloprid | Penetration^{a}* | Penetration^{a}* | Penetration^{a}** |
|---|---|---|---|---|
| Formu- | concentration | after 1 day | after 2 days | after 5 days |
| lation | (g/l) | (±SE) | (±SE) | (±SE) |
| Confidor | 0.2 | 3.8% | 6.0% | 12.3% |
| SL200 | | (±0.5) | (±0.8) | (±1.5) |
| (known) | | | | |
| Confidor | 0.2 | 5.% | 9.2% | 16.9% |
| SL200 | | (±0.8) | (±1.0) | (±1.6) |
| (according | | | | |
| to the | | | | |
| invention) | | | | |

^{a}Mean of 18-20 repetitions for the penetration through apple leaf cuticles;
*at 20° C., 60% atmospheric humidity;
**after 96 hours temperature increase to 30° C. (at 60% atmospheric humidity)

Also studied was the effect of additives, such as, for example, the isodecyl alcohol ethoxylate “Trend 90” (DuPont de Nemours, Bad Homburg) and the rapeseed oil methyl ester “Mero” (Bayer CropScience, Langenfeld) (Table B), and the known formulation of imidacloprid was compared to the formulation according to the invention.

TABLE B

| | | Additive | | |
|---|---|---|---|---|
| | Imidacloprid | concen- | | |
| | concentration | tration | Penetration^{a}* | Penetration** |
| Adjuvant | (g/l) | (g/l) | after 20 h | after 2 days |
| Confidor | 0.2 | Trend ® 90 | 27% | 44% |
| SL200 | | 0.1 | | |
| (known) | | | | |
| Confidor | 0.2 | Trend ® 90 | 33% | 58% |
| SL200 | | 0.1 | | |
| (according | | | | |
| to the | | | | |
| invention) | | | | |
| Confidor | 0.2 | Mero ® 1 | 70% | 85% |
| SL200 | | | | |
| (known) | | | | |
| Confidor | 0.2 | Mero ® 1 | 76% | 96% |
| SL200 | | | | |
| (according | | | | |
| to the | | | | |
| invention) | | | | |

^{a}Mean of 4-6 repetitions for the penetration through apple leaf cuticles;
*at 20° C., 60%;
**after 27 h temperature increase to 30° C. (at 60%)

### Example 3

### Effect of a Formulation According to the Invention Based on Imidacloprid and Propylene Carbonate (for the Composition, see Example 1)

Myzus persicae Test

To prepare a solution suitable for application, 1 part by weight of formulated product is mixed with water to give the desired concentration.

Discs of Chinese cabbage leaves (Brassica pekinensis) infested by all stages of the green peach aphid (Myzus persicae) are sprayed with an application solution of the desired concentration.

After the desired period of time, the effect in % is determined. 100% means that all aphids have been killed; 0% means that none of the aphids have been killed.

In this test, for example, the following formulation of the example according to the invention exhibits an efficacy superior to that of the prior art (Table C):

TABLE C
Myzus persicae test

| | Concentration | Kill |
|---|---|---|
| Active compound/product | in ppm | in % after 5^{d} |
| Confidor SL 200 | 8 | 33 |
| contains propylene carbonate | | |
| (according to the invention) | | |
| Confidor SL 200 | 8 | 10 |
| contains NMP | | |
| (known) | | |

### Example 4

### Effect of a Formulation According to the Invention Based on Imidacloprid and Propylene Carbonate (for the Composition, see Example 1)

Plutella xylostella Test (Normally Sensitive)

To prepare a solution suitable for application, 1 part by weight of formulated product is mixed with water to give the desired concentration.

Discs of Chinese cabbage leaves (Brassica pekinensis) are sprayed with an application solution of the desired concentration and, after the spray coating has dried on, populated with larvae of the diamond back moth (Plutella xylostella).

After the desired period of time, the effect in % is determined. 100% means that all caterpillars have been killed; 0% means that none of the caterpillars have been killed.

In this test, for example, the following formulation of the example according to the invention exhibits an efficacy superior to that of the prior art (Table D):

TABLE D
Plutella xylostella test (sensitive strain)

| | Concentration | Kill |
|---|---|---|
| Active compound/product | in ppm | in % after 3^{d} |
| Confidor SL 200 | 120 | 93 |
| contains propylene carbonate | | |
| (according to the invention) | | |
| Confidor SL 200 | 120 | 57 |
| contains NMP | | |
| (known) | | |

### Example 5

### Effect of a Formulation According to the Invention Based on Imidacloprid and Propylene Carbonate (for the Composition, See Example 1)

### Plant Compatibility—Soyabean

To prepare a solution suitable for application, 1 part by weight of formulated product is mixed with water to give the desired concentration.

Soyabean plants (Glycine max) are sprayed to runoff point with an application solution of the desired concentration.

After the desired period of time, the damage to the plant is determined in %. 100% means that the entire plant has been damaged; 0% means that no damage is visible. In this test, for example, the following formulation of the example according to the invention exhibits an efficacy superior to that of the prior art (Table E):

TABLE E
Soyabean

| | Concentration | Damage |
|---|---|---|
| Active compound/product | in ppm | in % after 7^{d} |
| Confidor SL 200 | 1000 | 0 |
| contains propylene carbonate | | |
| (according to the invention) | | |
| Confidor SL 200 | 1000 | 10 |
| contains NMP | | |
| (known) | | |

1. An active compound formulation for use in crop protection, comprising at least
a) a crop protection agent,
b) one a solvent, and
c) propylene carbonate.

2. The active compound formulation according to claim 1, comprising at least
a) a crop protection agent,
b) one a solvent,
c) propylene carbonate,
d) an emulsifier,
e) a dispersant, and
f) optionally an additive.

3. The active compound formulation according to claim 2, wherein
a) said crop protection agent is from 0.1 to 40% by weight,
b) said emulsifier is from 0.5 to 30% by weight,
c) said solvent is from 30 to 90% by weight,
d) said propylene carbonate is from 10 to 50% by weight, and
e) said dispersant is from 0 to 10% by weight.

4. The active compound formulation according to claim 1, wherein said crop protection agent is imidacloprid.

5. The active compound formulation according to claim 1, wherein said crop protection agent is selected from the group consisting of clothianidin, thiacloprid, thiamethoxam, nitenpyram, acetamiprid and dinotefuran.

6. The active compound formulation according to claim 2, wherein said dispersant is a copolymer of polyvinylpyrrolidone and polyvinyl acetate.

7. The active compound formulation according to claim 1, wherein said solvent is dimethyl sulphoxide.

8. A process for preparing an active compound formulation according to claim 1, comprising:
a) dissolving a crop protection agent in a mixture of one or more solvents and propylene carbonate,
b) adding one or more emulsifiers and one or more dispersants with stirring, and
c) homogenizing the mixture obtained from (b) to form a clear and homogeneous solution.

9. A method for treating plants or protecting plants against pests, comprising contacting said plants or their habitat with an active compound formulation according to claim 1.

10. A method for increasing the efficacy of a crop protection agent or a combination of crop protection agents, comprising formulating said crop protection agent or combination of crop protection agents in an active compound formulation according to claim 1.

11. (canceled)
